(19) United States
(12) Patent Application Publication
(10) Pub. No.: US 2014/0274095 A1
(43) Pub. Date: Sep. 18, 2014

(54) MOBILE TERMINAL AND CONTROL METHOD

(71) Applicant: FUJITSU LIMITED, Kawasaki-shi (JP)

(72) Inventor: Naritoshi SAITO, Hino (JP)

(73) Assignee: FUJITSU LIMITED, Kawasaki-shi (JP)

(21) Appl. No.: 14/138,388

(22) Filed: Dec. 23, 2013

(30) Foreign Application Priority Data
Mar. 18, 2013 (JP) 2013-055685

(51) Int. Cl. H04W 72/08

(52) U.S. Cl. CPC H04W 72/085
USPC 455/452.1

(57) ABSTRACT

A mobile terminal includes a receiving unit configured to enable reception of a wireless signal by concurrently using a cell of a first frequency bandwidth and a cell of a second frequency bandwidth that is different from the first frequency bandwidth, where the cell of the second frequency bandwidth having a range that is smaller than the cell of the first frequency bandwidth; a measuring unit configured to measure reception quality of each cell of the second frequency bandwidth; a setting unit configured to set among the cells of the second frequency bandwidth and based on a result of measurement, a cell that is to be used by the receiving unit; a detecting unit configured to detect a movement speed of the mobile terminal; and a control unit configured to terminate the measurement when the detected movement speed exceeds a predetermined speed.

### CROSS REFERENCE TO RELATED APPLICATIONS

This application is based upon and claims the benefit of priority of the prior Japanese Patent Application No. 2013-055685, filed on Mar. 18, 2013, the entire contents of which are incorporated herein by reference.

### FIELD

The embodiments discussed herein are related to a mobile terminal and a control method.

### BACKGROUND

Long Term Evolution (LTE) and LTE-Advanced (LTE-A) are conventionally known mobile communication schemes. Under LTE and LTE-A, for example, Orthogonal Frequency Division Multiplexing Access (OFDMA) is used.

Under LTE-A, carrier aggregation (CA), which bundles and uses multiple component carriers (CC), is employed. The carrier aggregation includes selecting a primary cell (main cell) and a secondary cell. (sub-cell), for example. Further, improved communication quality is facilitated by changing the secondary cell based on search results for the secondary cell.

According to a known technique, reductions in handover processing for a terminal is achieved by using a virtual wireless identifier as a common ID at multiple base stations (see, e.g., Japanese Laid-Open Patent Publication No. 2012-019348). According to another known technique, a mobile terminal concurrently uses a first carrier of a first frequency bandwidth and a second carrier of a second frequency bandwidth that is of a higher frequency bandwidth than the first frequency bandwidth, so as to transmit and receive signals with respect to a wireless base station (see, e.g., Japanese Laid-Open Patent Publication No. 2011-142596). According to yet another known technique, during communication with a wireless communication terminal in a microcell, the communication is switched to communication using a macrocell in response to reception timing of a signal transmitted from the wireless communication terminal (see, e.g., Japanese Laid-Open Patent Publication No. 2010-147848).

However, in the conventional techniques described above, even when a cell search, which has large power consumption, is performed for changing, etc. a secondary cell, communication quality may not be improved depending on the state of a mobile terminal. Therefore, it is problematic that electric power cannot be used efficiently.

### SUMMARY

According to an aspect of an embodiment, a mobile terminal includes a receiving unit that is configured to enable reception of a wireless signal by concurrently using a cell of a first frequency bandwidth and a cell of a second frequency bandwidth that is different from the first frequency bandwidth, the cell of the second frequency bandwidth having a range that is smaller than the cell of the first frequency bandwidth; a measuring unit that is configured to measure reception quality of each cell of the second frequency bandwidth; a setting unit that is configured to set among the cells of the second frequency bandwidth and based on a result of measurement, a cell that is to be used by the receiving unit; a detecting unit that is configured to detect a movement speed of the mobile terminal; and a control unit that is configured to terminate the measurement when the detected movement speed exceeds a predetermined speed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram of an example of a communication system according to an embodiment;

FIG. 1B is a diagram of an example of signal flow in the communication system depicted in FIG. 1A;

FIG. 1C depicts an example of cells that can be used by a mobile terminal to receive a wireless signal;

FIG. 2 is a diagram of an example of carrier aggregation;

FIG. 3 is a diagram of an example of frame mapping of a downlink physical channel;

FIG. 4 is a sequence diagram of an example of message flow between a mobile terminal and a network;

FIGS. 5, 6, and 7 are flowcharts of an example of operation of the mobile terminal;

FIG. 8 is a flowchart of an example of a setting process of Scell_nouse_flg;

FIG. 9A is a diagram of an example of a first event group;

FIG. 9B is a diagram of an example of a second event group;

FIG. 10A is a diagram of an example of a hardware configuration of the mobile terminal;

FIG. 108 is a diagram of an example of signal flow in the hardware configuration of the mobile terminal depicted in FIG. 10A; and

FIG. 11 is a diagram of an example of detection of requested downlink throughput.

### DESCRIPTION OF EMBODIMENTS

Embodiments of a mobile terminal and a control method will be described in detail with reference to the accompanying drawings.

FIG. 1A is a diagram of an example of a communication system according to an embodiment. FIG. 1B is a diagram of an example of signal flow in the communication system depicted in FIG. 1A. FIG. 1C depicts an example of cells that can be used by a mobile terminal to receive a wireless signal.

As depicted in FIGS. 1A and 18, a communication system 100 according to the embodiment includes a mobile terminal 110 and a base station 120. The mobile terminal 110 performs wireless communication with the base station 120. The base station 120 may be multiple base stations.

Cells 131, 132, and a cell group 133 depicted in FIG. 1C are cells that can be used by the mobile terminal 110 to receive wireless signals. The cells 131 and 132 are cells that use a first frequency bandwidth b1. The cell group 133 is made up of cells that use a second frequency bandwidth b2 that is different from the first frequency bandwidth b1. As depicted in FIG. 1C, the cells of the cell group 133 are cells that overlap at least any one among the cells 131 and 132, and cover a range (coverage area) that is smaller than the cells 131 and 132.

As depicted in FIGS. 1A and 18B, the mobile terminal 110 includes a receiving unit 111, a measuring unit 112, a setting unit 113, a detecting unit 114, and a control unit 115. The receiving unit 111 receives wireless signals from the base station 120. The receiving unit 111 can receive the wireless signals by concurrently using a cell of the first frequency bandwidth b1 (e.g., either of the cells 131 and 132) and a cell of the second frequency bandwidth b2 (e.g., any cell in the cell group 133) depicted in FIG. 1C.

A cell of the second frequency bandwidth b2 is a cell covering a range that is smaller than that of a cell of the first frequency bandwidth b1 and therefore, if the mobile terminal 110 moves at high speed, communication quality deteriorates more frequently and, for example, communication is interrupted more frequently in a cell of the second frequency bandwidth b2 as compared to a cell of the first frequency bandwidth b1.

The measuring unit 112 measures reception quality for the cells including sectors) of the second frequency bandwidth b2. The measurement of reception quality by the measuring unit 112 is a cell search that measures path loss for each cell, for example. The measuring unit 112 outputs results of the measurement to the setting unit 113. The reception quality measured by the measuring unit 112 is, for example, Received Signal Strength Indicator (RSSI) or Carrier to Interference and Noise Ratio (CINR).

The setting unit 113 sets a cell that is to be used by the receiving unit 111, from among the cells of the second frequency bandwidth b2 based on the measurement result output from the measuring unit 112. For example, the setting unit 113 wirelessly transmits to the base station 120, information that includes the measurement result output from the measuring unit 112, whereby the base station 120 determines the cell that is to be used by the receiving unit 111 among the cells of the second frequency bandwidth b2. The setting unit 113 then wirelessly receives from the base station 120, information indicating a result of the determination by the base station 120. The setting unit 113 sets the cell that is to be used by the receiving unit 111 among the cells of the second frequency bandwidth b2 to the bandwidth indicated by the information received wirelessly.

The detecting unit 114 detects a movement speed of the mobile terminal 110 (the terminal of the detecting unit 114). The detecting unit 114 outputs a result of the detection to the control unit 115. Based on the detection result output from the detecting unit 114, if the movement speed of the mobile terminal 110 exceeds a predetermined speed, the control unit 115 terminates the measurement of reception quality for the cells of the second frequency bandwidth b2 by the measuring unit 112.

As a result, during high-speed movement when the reception quality of cells of the second frequency bandwidth b2 drops frequently, the measurement for selecting a cell of the second frequency bandwidth b2 is not performed, thereby curbing the execution of measurements that do not lead to improvement in communication quality. During high-speed movement when the reception quality of cells of the second frequency bandwidth b2 drops frequently, processes such as changing the cell of the second frequency bandwidth b2 are not executed, thereby curbing the execution of processes that do not lead to improvement in communication quality. As a result, wasteful power consumption can be reduced to enable efficient electric power use. Thus, for example, the battery life of the mobile terminal 110 can be improved.

Based on a monitoring result of occurrence of events, the setting unit 113 sets a bandwidth that is to be used by the receiving unit 111, for example. The events include a predetermined event that is based on a reception quality measurement result for the cells of the second frequency bandwidth b2. Since the predetermined event does not occur if the measurement of reception quality is not performed for the cells of the second frequency bandwidth b2, when the detected movement speed exceeds a predetermined speed, the setting unit 113 may terminate the monitoring of the occurrence of the predetermined event. Electric power can be used efficiently by eliminating the process of monitoring events that cannot occur.

After terminating the measurement of reception quality for the cells of the second frequency bandwidth b2, if the detected movement speed becomes less than or equal to the predetermined speed, the control unit 115 may resume the measurement of reception quality for the cells of the second frequency bandwidth b2. As a result, during low-speed movement that enables stabilized the reception quality of cells of the second frequency bandwidth b2, the reception quality of the cells of the second frequency bandwidth b2 can be measured to set one of cells based on the measurement result, thereby enabling improvement in communication quality.

The detecting unit 114 may detect the remaining battery amount of the mobile terminal 110 in addition to the movement speed of the mobile terminal 110. If the remaining battery amount detected by the detecting unit 114 falls below a predetermined remaining amount, the control unit 115 terminates the measurement of reception quality for the cells of the second frequency bandwidth b2 by the measuring unit 112, even when the movement speed of the mobile terminal 110 does not exceed the predetermined speed. As a result, the measurement of reception quality for the cells of the second frequency bandwidth b2 can be curbed when the remaining battery amount of the mobile terminal 110 is low. Therefore, the battery can be prevented from being exhausted consequent to attempts to improve the communication quality when the remaining battery amount of the mobile terminal 110 is low.

In this case, after terminating the measurement of reception quality for the cells of the second frequency bandwidth b2, if the detected remaining battery amount becomes greater than or equal to the predetermined remaining amount and the detected movement speed is less than or equal to the predetermined speed, the control unit 115 may resume the terminated measurement. As a result, if the remaining battery amount of the mobile terminal 110 becomes increases consequent to charging, etc., the reception quality of cells of the second frequency bandwidth b2 can be measured to set a cell of the second frequency bandwidth b2 based on the measurement result, thereby enabling improvement in the communication quality.

The detecting unit 114 may detect a data amount requested by the mobile terminal 110 to, for example, the base station 120 for transmission to the mobile station 110, in addition to the movement speed of the mobile terminal 110. If the data amount detected by the detecting unit 114 falls below a predetermined data amount, the control unit 115 terminates the measurement of reception quality for the cells of the second frequency bandwidth b2 by the measuring unit 112, even when the movement speed of the mobile terminal 110 does not exceed the predetermined speed. As a result, the measurement of reception quality for the cells of the second frequency bandwidth b2 can be curbed when the data amount requested by the mobile terminal 110 is low. Therefore, power consumption can be prevented from increasing consequent to attempts to improve the communication quality when the data amount requested by the mobile terminal 110 is low.

In this case, after terminating the measurement of reception quality for the cells of the second frequency bandwidth b2, if the detected data amount becomes greater than or equal to the predetermined data amount and the detected movement speed is less than or equal to the predetermined speed, the control unit 115 may resume the terminated measurement. As a result, if the data amount requested by the mobile terminal 110 increases, the reception quality of cells of the second frequency bandwidth b2 can be measured to set a cell of the second frequency bandwidth b2 based on the measurement result, thereby enabling improvement in the communication quality according to increases in requested data amount.

For example, the detecting unit 114 detects a data amount corresponding to the state of an application under execution by the mobile terminal 110, based on correlation information of the state of an application that can be executed in the mobile terminal 110 (the terminal of the detecting unit 114) and the data amount requested by the mobile terminal 110.

The mobile terminal 110 is applicable to a mobile terminal capable of wireless communication such as LTE, LTE-A, and via a wireless local area network (LAN), for example. A case where the mobile terminal 110 is applied to a mobile terminal capable of LTE-A wireless communication will be described hereinafter.

FIG. 2 is a diagram of an example of carrier aggregation. The horizontal axis of FIG. 2 indicates frequency. Bandwidth A depicted in FIG. 2 is a frequency bandwidth of 800 [MHz]. Bandwidth B is a frequency bandwidth of 3.5 [GHz] to 3.8 [GHz]. The carrier aggregation under LTE-A is performed by, for example, four component carriers including one component carrier 210 in bandwidth A and three component carries 221 to 223 in bandwidth B.

In this case, when it is assumed that a bandwidth of each of the component carriers 210 and 221 to 223 is 20 [MHz], a service can be performed with up to 80 [MHz] in width. Such carrier aggregation is referred to as inter frequency carrier aggregation, for example. Bandwidth A of 800 [MHz] is called, for example, a platinum bandwidth and compared to bandwidth B, enables easy signal reception.

The first frequency bandwidth b1 depicted in FIG. 1C corresponds to the bandwidth A depicted in FIG. 2, for example. The second frequency bandwidth b2 depicted in FIG. 1C corresponds to the bandwidth B depicted in FIG. 2, for example. The mobile terminal 110 uses, for example, the component carrier 210 of the bandwidth A as a primary component carrier (primary CC). The mobile terminal 110 uses the component carriers 221 to 223 of the bandwidth B as secondary component carriers (secondary CCs).

In this case, for the mobile terminal 110, a cell using the component carrier 210 is a primary cell and a cell using the component carriers 221 to 223 is a secondary cell.

FIG. 3 is a diagram of an example of frame mapping of a downlink physical channel. In FIG. 3, the horizontal direction indicates time and the vertical direction indicates frequency. The frame 310 represents one frame in the downlink physical channel in the mobile terminal 110. A length of the frame 310 is 10 [ms] and the frame 310 is repeatedly transmitted in the downlink physical channel. The frame 310 includes 1.0 sub-frames having a length of 1 [ms].

A sub-frame 320 represents one sub-frame in the frame 310. The sub-frame 320 includes two slots. A slot 330 represents one slot in the sub-frame 320. The slot 330 includes seven OFDM symbols. Each OFDM symbol of the slot 330 includes at the beginning a cyclic prefix (CP) that is a copy of an end portion of each symbol.

The sub-frame 320 includes, for example, a 1.0 primary synchronization signal. 321, a secondary synchronization signal 322, a physical broadcast channel (PBCH) 323, a physical downlink control channel (PDCCH) 324, a physical downlink shared channel (PDSCH) 325, and a reference signal (RS) 326. At the time of a cell search, the mobile terminal 110 executes a synchronization process by using the primary synchronization signal 321 and the secondary synchronization signal 322, thereby demodulating the cell ID to identify the cell.

The mobile terminal 110 measures RSSI, Reference Signal Received Power (RSRP), and Reference Signal Received Quality (RSRQ) based on 3GPP Specification 36.214 under LTE-A, for example.

The measurement of RSSI is by wireless power measurement such as wireless power measurement of a signal with noise and interference components added in addition to a cell signal. The measurement of RSRP is by power measurement of the reference signal 326, for example. The reference signal 326 is mapped to symbol “0” and symbol “4” in each slot.

For example, RSRQ is acquired by dividing RSRP, which is power of the reference signal 326, by RSSI, and corresponds to Signal to Interference and Noise Ratio (SINR), for example.

FIG. 4 is a sequence diagram of an example of message flow between the mobile terminal and a network. The Evolved Universal Terrestrial Radio Access Network (EUTRAN) 410 depicted in FIG. 4 is provided at the base station 120, for example. The EUTRAN 410 may be provided in a higher-order communication apparatus than the base station 120. In this case, the mobile terminal 110 communicates with the EUTPAN 410, via the base station 120.

Under LTE-A (e.g., 3GPP TS36.33), for example, the following steps are periodically executed. First, the mobile terminal 110 transmits a measurement report to the EUTRAN 410 (step S401). The measurement report includes information based on measurement results of RSSI, RSRP, and RSRQ from the cell search described above, for example.

The EUTRAN 410 determines details of a setting change for the mobile terminal 110 (including “no change”) based on the measurement report transmitted at step S401 (step S402). The setting change may be, for example, an addition or cancellation of a secondary CC, a switching of the primary CC and a secondary CC, etc. The EUTRAN 410 transmits to the mobile terminal 110, a RRC connection reconfiguration including information indicating details of the setting change determined at step S402 (step S403).

The mobile terminal 110 makes the setting change based on the RRC connection reconfiguration transmitted at step S403 (step S404). The mobile terminal. 10 transmits to the EUTRAN 410, “RRC connection reconfiguration complete” indicating the completion of the setting change (step S405) and terminates a sequence of the message flow.

According to the operations above, the EUTRAN 410 determines a setting change for the mobile terminal 110 based on the results of periodical cell searches in the mobile terminal 110, and the setting change of the mobile terminal 110 is performed according to the determination result.

FIGS. 5, 6, and 7 are flowcharts of an example of operation of the mobile terminal. When powered on, the mobile terminal 110 executes the operations depicted in FIGS. 5 to 7, for example. First, as depicted in FIG. 5, the mobile terminal 110 performs a primary cell search for detecting the primary cell using the primary CC having good reception performance (step S501). The primary cell search is a cell search for the component carrier 210 (primary CC) depicted in FIG. 2, for example. The primary cell search at step S501 may be a cell search for detecting the primary cell set when the mobile terminal 110 was powered off last, for example.

The mobile terminal 110 starts communication via the primary cell detected at step S501 (step S502). The mobile terminal 110 acquires secondary CC information through dedicated signaling via the primary cell detected at step S501 (step S503). The SCC information is information indicating the frequency bandwidth of the secondary CC, for example.

The mobile terminal 110 then proceeds to the operations depicted in FIG. 6 (reference character A). In particular, the mobile terminal 110 performs the primary cell search (step S601). The mobile terminal 110 then sets Scell_nouse_flg (step S602). Scell_nouse_flg is information that is set to “1” if the secondary cell search is not to be performed and set to “0” if the secondary cell search is to be performed. The setting of Scell_nouse_flg will be described later (see, e.g., FIG. 8).

The mobile terminal 110 determines whether Scell_nouse_flg set at step S602 is “1” (step S603). If Scell_nouse_flg is not “1” (step S603: NO), the mobile terminal 110 performs the secondary cell search (step S604). The secondary cell search is a cell search for the component carriers 221 to 223 (secondary CCs) depicted in FIG. 2, for example. The mobile terminal 110 checks a first event group (see, e.g., FIG. 9A) (step S605) and proceeds to step S607.

If Scell_nouse_flg is “1” at step S603 (step S603: YES), the mobile terminal 110 does not perform the secondary cell search and checks a second event group (see, e.g., FIG. 9B) (step S606).

The mobile terminal 110 determines whether the occurrence of an event has been detected by the check at step S605 or step S606 (step S607). If no occurrence of an event is detected (step S607: NO), the mobile terminal 110 sets a timer T1 that times a predetermined period (step S608).

The mobile terminal 110 determines whether the timer T1 set at step S608 has expired (step S609) and if not, waits for the timer T1 to expire (step S609: NO). When the timer T1 expires (step S609: YES), the mobile terminal 110 returns to step S601.

If the occurrence of an event has been detected at step S607 (step S607: YES), the mobile terminal 110 uses the primary cell to report the detected event to the network through a measurement report (step S610). The network is the EUTRAN 410 depicted in FIG. 4, for example.

The mobile terminal 110 determines whether a RRC connection reconfiguration (RRC_Conn_Recf) has been received from the network (step S611). If RRC_Conn_Recf has not been received (step S611: NO), the mobile terminal 110 proceeds to step S608.

If RRC_Conn_Recf has been received at step S611 (step S611: YES), the mobile terminal 110 proceeds to the operations depicted in FIG. 7 (reference character B). In other words, the mobile terminal 110 determines if the received RRC_Conn_Recf is information instructing the addition or cancellation of a secondary CC (step S701).

If RRC_Conn_Recf is not an instruction for the addition or cancellation of a secondary CC (step S701: NO), the mobile terminal 110 proceeds to step S703. If RRC_Conn_Recf is an instruction for the addition or cancellation of a secondary CC (step S701: YES), the mobile terminal 110 adds or cancels a secondary CC according to RRC_Conn_Recf (step S702).

The mobile terminal 110 determines whether received RRC_Conn_Recf is an instruction for switching a primary CC and a secondary CC (step S703). If RRC_Conn_Recf is not an instruction for switching a primary CC and a secondary CC (step S703: NO), the mobile terminal 110 proceeds to step S705.

At step S703, if RRC_Conn_Recf is an instruction for switching of a primary CC and a secondary CC (step S703: YES), the mobile terminal 110 proceeds to step S704. In other words, the mobile terminal 110 switches the primary CC and the secondary CC according to RRC_Conn_Recf (step S704).

The mobile terminal 110 sets the timer T1 that times a predetermined period (step S705). The mobile terminal 10 determines whether the timer T1 set at step S705 has expired (step S706) and if not, waits for the timer T1 to expire (step S706: NO). When the timer T1 expires at step S706 (step S706: YES), the mobile terminal 110 returns to step S601 depicted in FIG. 6 (reference character A).

By the operations depicted in FIGS. 5 to 7, the mobile terminal 110 checks events for each period timed by the timer T1 and if the occurrence of an event is detected, the mobile terminal 110 makes a report to the network and performs a setting change if an instruction for a setting change is issued by the network. Further, if Scell_nouse_flg is “0”, the mobile terminal 110 performs the secondary cell search and checks the first event group. If Scell_nouse_flg is “1”, the mobile terminal 110 checks the second event group without performing the secondary cell search.

The period timed by the timer T1 can be set to about 30 seconds to 180 seconds to reflect the movement speed, the remaining battery amount, etc. of the mobile terminal 110, for example.

FIG. 8 is a flowchart of an example of a setting process of Scell_nouse_flg. At step S602 depicted in FIG. 6, the mobile terminal 110 executes, for example, the following steps as the setting process of Scell_nouse_flg.

The mobile terminal 110 determines whether the movement speed Vm of the mobile terminal 110 is greater than a threshold value Vth1 (step S801). The threshold value Vth1 can be set to 15 [km/h], for example. If the movement speed Vm is greater than the threshold value Vth1 (step S801: YES), the mobile terminal 110 sets Scell_nouse_flg to “1” (step S802) and terminates the setting process of Scell_nouse_flg.

If the movement speed Vm is not greater than the threshold value Vth1 at step S801 (step S801: NO), the mobile terminal 110 determines whether the remaining battery amount VT of the mobile terminal 110 is less than a threshold value VTth1 (step S803). The threshold value VTth1 can be set to 25%, for example. If the remaining battery amount VT is less than the threshold value VTth1 (step S803: YES), the mobile terminal 110 proceeds to step S802 and sets Scell_nouse_flg to “1” and terminates the setting process of Scell_nouse_flg.

If the remaining battery amount VT is not less than the threshold value VTth1 at step S803 (step S803: NO), the mobile terminal 110 determines whether a requested downlink throughput Dreq of the mobile terminal 110 is less than a threshold value Dreq_th1 (step S804). The threshold value Dreq_th1 may be set to 7 [Mbps], for example. If the requested downlink throughput Dreq is less than the threshold value Dreq_th1 (step S804: YES), the mobile terminal 110 proceeds to step S802 and sets the Scell_nouse_flg to “1” and terminates the setting process of Scell_nouse_flg.

If the requested downlink throughput Dreq is not less than the threshold value Dreq_th1 at step S804 (step S804: NO), the mobile terminal 110 sets Scell_nouse_flg to “0” (step S805) and terminates the setting process of Scell_nouse_flg.

As a result of the operations depicted in FIG. 8, if the mobile terminal 110 is moving at high speed and the remaining battery amount of the mobile terminal 110 is low, or if the requested downlink throughput of the mobile terminal 110 is low, the mobile terminal 110 can set Scell_nouse_flg to “1”. If the mobile terminal 110 is not moving at high speed and the remaining battery amount of the mobile terminal 110 is high, and if the requested downlink throughput of the mobile terminal 110 is high, the mobile terminal 110 can set Scell_nouse_flg to “0”.

As a result of the operations depicted in FIGS. 5 to 8, when the mobile terminal 110 is moving at high speed and if the remaining battery amount of the mobile terminal 110 is low or if the requested downlink throughput of the mobile terminal 110 is low, the mobile terminal 110 can refrain from performing the secondary cell search. When the mobile terminal 110 is not moving at high speed and if the remaining battery amount of the mobile terminal 110 is high, and if the requested downlink throughput of the mobile terminal 110 is high, the mobile terminal 110 may perform the secondary cell search. As a result, wasteful secondary cell search and event report can be suppressed to reduce power consumption.

If the secondary cell search is not performed, no state change of the secondary cell is reported to the network and therefore, the network does not instruct the addition or cancellation of the secondary CC nor the switching of the primary cell and the secondary cell. As a result, a reduction of the power consumed for the addition or cancellation of the secondary CC and the switching of the primary cell and the secondary cell is enabled.

Among the steps depicted in FIG. 8, for example, step S803 may be omitted and, if the movement speed Vm is not greater than the threshold value Vth1 at step S801, the mobile terminal 110 may proceed to step S804. As a result, if the mobile terminal 110 is moving at high speed or if the requested downlink throughput of the mobile terminal 110 is low, Scell_nouse_flg is set to “1”. If the mobile terminal 110 is not moving at high speed and if the requested downlink throughput of the mobile terminal 110 is high, Scell_nouse_flg is set to “0”.

Among the steps depicted in FIG. 8, for example, step S804 may be omitted and, if the remaining battery amount VT is not less than the threshold value VTth1 at step S803, the mobile terminal 110 may proceed to step S805. As a result, if the mobile terminal 110 is moving at high speed or if the remaining battery amount of the mobile terminal 110 is low, Scell_nouse_flg can be set to “1”. If the mobile terminal 110 is not moving at high speed and if the remaining battery amount of the mobile terminal 110 is high, Scell_nouse_flg can be set to “0”.

Among the steps depicted in FIG. 8, for example, steps S803 and S804 may be omitted and, if the movement speed Vm is not greater than the threshold value Vth1 at step S801, the mobile terminal 110 may proceed to step S805. As a result, if the mobile terminal 110 is moving at high speed, Scell_nouse_flg can be set to “1” and if the mobile terminal 110 is not moving at high speed, Scell_nouse_flg can be set to “0”.

FIG. 9A is a diagram of an example of the first event group. The first event group checked at step S605 of FIG. 6 is an event group described in a table 910 depicted in FIG. 9A, for example. In other words, the event group described in the table 910 is an event group that is checked when a secondary search is performed. As depicted in the table 910, the first event group includes “Event A1” to “Event A6”, “Event B1”, and “Event B2”.

“Event A1” to “Event A6”, “Event B1”, and “Event B2” are events defined under TS36.331 of 3rd Generation Partnership Project (3GPP), for example.

“Event A1” is an event occurring when power of a serving cell becomes better than a threshold value. “Event A2” is an event occurring when the power of a serving cell becomes lower than a threshold value. “Event A3” is an event that occurs when the power of a neighbour cell becomes better than an offset determined by comparison with the primary cell.

“Event A4” is an event that occurs when the power of a neighbour cell becomes better than a threshold value. “Event A5” is an event that occurs when the power of the primary cell becomes lower than a threshold value and the power of a neighbour cell becomes better than a threshold value. “Event A6” is an event that occurs when the power of a neighbour cell becomes better than an offset determined by comparison with the power of the secondary cell.

“Event B1” is an event that occurs when the power of an Inter RAT (another wireless system) neighbour cell becomes better as compared to a threshold value. “Event B2” is an event that occurs when the power of the primary cell becomes lower than a threshold value and power of an Inter RAT (another wireless system) neighbour cell becomes better than a threshold value.

“Event A3” and “Event A6” of the first event group described in the table 910 are events that may occur as a result of the secondary cell search. On the other hand, the events other than “Event A3” and “Event A6” of the first event group are events that may occur even when the secondary cell search is not performed.

FIG. 98 is a diagram of an example of the second event group. The second event group checked at step S606 of FIG. 6 is an event group described in a table 920 depicted in FIG. 98, for example. In other words, the event group described in the table 920 is an event group that is checked when no secondary search is performed. As depicted in the table 920, the second event group includes “Event A1”, “Event A2”, “Event A4”, “Event A5”, “Event B1”, and “Event B2”. The second event group does not include “Event A3”, which is included in the first event group depicted in FIG. 9A.

As described above, if no secondary cell search is performed, no check may be made for “Event A3” and “Event A6” that may occur only when the secondary cell search is performed. As a result, a processing amount in the mobile terminal 110 can be reduced.

FIG. 10A is a diagram of an example of a hardware configuration of the mobile terminal. FIG. 10B is a diagram of an example of signal flow in the hardware configuration of the mobile terminal depicted in FIG. 10A. As depicted in FIGS. 10A and 10B, the mobile terminal 110 includes an antenna 1001, an LTE-A device 1010, a central processing unit (CPU) 1021, memory 1022, a display unit 1031, an operating unit 1032, a microphone 1033, a speaker 1034, a terminal speed detecting unit 1041, a remaining battery amount detecting unit 1042, and a requested downlink throughput detecting unit 1043.

The LTE-A device 1010 is a communication circuit executing a communication process in the LTE-A mode. For example, the LTE-A device 1010 has an LTE-A wireless unit 1011 and an LTE-A baseband unit 1012. According to the LTE-A scheme, the LTE-A wireless unit 1011 wirelessly transmits, via the antenna 1001, a transmission signal output from the LTE-A baseband unit 1012. The LTE-A wireless unit 1011 outputs to the LTE-A baseband unit 1012, a reception signal received via the antenna 1001 according to the LTE-A scheme.

The LTE-A baseband unit 1012 executes a baseband process on a transmission signal output from the CPU 1021 and outputs the transmission signal subjected to the baseband process to the LTE-A wireless unit 1011. The LTE-A baseband unit 1012 executes a baseband process on a reception signal output from the LTE-A wireless unit 1011 and outputs the reception signal subjected to the baseband process to the CPU 1021.

The CPU 1.021 is responsible for overall control of the mobile terminal 110. For example, the operations depicted in FIGS. 5 to 8 are executed by the CPU 1021.

The memory 1022 includes main memory and auxiliary memory, for example. The main memory is random access memory (RAM), for example. The main memory is used as a work area of the CPU 1021. The auxiliary memory is non-volatile memory such as a magnetic disk and a flash memory. The auxiliary memory stores various programs for operating the mobile terminal 110. The programs stored in the auxiliary memory are loaded to the main memory and executed by the CPU 1021.

The display unit 1031 displays information for a user of the mobile terminal 110, under the control of the CPU 1021. The display unit 1031 may be implemented by a liquid crystal display, for example. The operating unit 1032 is manipulated by the user of the mobile terminal 110 and notifies the CPU 1021 of the details of the manipulation. The operating unit 1032 may be implemented by switches and keys, for example. The display unit 1031 and the operating unit 1032 may be implemented by a touch panel, etc. The microphone 1033 receives audio input from the user and notifies the CPU 1021 of the contents of the input received. The speaker 1034 outputs sound to the user of the mobile terminal 110, under the control, of the CPU 1021.

The terminal speed detecting unit 1041 detects the movement speed of the mobile terminal 110. The terminal speed detecting unit 1041 detects the movement speed by using an acceleration sensor, for example. However, this is not a limitation of the detection of the movement speed by the terminal speed detecting unit 1041 and various methods are available. For example, the terminal speed detecting unit 1041 may detect the movement speed based on the frequency and phase of a signal received by the antenna 1001.

The terminal speed detecting unit 1041 may acquire positional information of the mobile terminal 110 via a Global Positioning System (GPS), etc. to detect the movement speed based on a change in the positional information. The terminal speed detecting unit 1041 may detect the movement speed based on a change of the base station communicating with the mobile terminal 110.

The remaining battery amount detecting unit 1042 detects the remaining battery amount of the mobile terminal 110. For example, the remaining battery amount detecting unit 1042 detects the remaining battery amount by measuring the battery voltage from current supplied by the battery of the mobile terminal 110.

The requested downlink throughput detecting unit 1043 detects the downlink communication throughput requested by the mobile terminal 110 to the network. The detection of downlink communication throughput by the requested downlink throughput detecting unit 1043 will be described later (see, e.g., FIG. 11).

The terminal speed detecting unit 1041, the remaining battery amount detecting unit 1042, and the requested downlink throughput detecting unit 1043 may be implemented by an electronic circuit etc., different from the CPU 1021, for example. Alternatively, the terminal speed detecting unit 1041, the remaining battery amount detecting unit 1042, and the requested downlink throughput detecting unit 1043 may be implemented by executing a program on the CPU 1021, for example.

The receiving unit 111 depicted in FIGS. 1A and 1B may be implemented by the antenna 1001 and the LTE-A device 1010, for example. The measuring unit 114 depicted in FIGS. 1A and B1 may be implemented by the antenna 1001, the LTE-A device 1010, and the CPU 1021, for example. The setting unit 113 and the control unit 115 depicted in FIGS. 1A and 1B may be implemented by the LTE-A device 1010 and the CPU 1021, for example. The detecting unit 114 depicted in FIGS. 1A and 1B may be implemented by the terminal speed detecting unit 1041, the remaining battery amount detecting unit 1042, and the requested downlink throughput detecting unit 1043, for example.

FIG. 11 is a diagram of an example of the detection of the requested downlink throughput. As 1.0 depicted in FIG. 11, for example, the mobile terminal 110 includes an application client 1110, a storage unit 1120, and a requested downlink throughput setting unit 1130. The application client 1110 and the requested downlink throughput setting unit 1130 may be implemented by executing a program on the CPU 1021, for example. The storage unit 1120 may be implemented by the memory 1022, for example.

For example, the application client 1110 is a client application performing a storage type streaming service (video streaming service). It is assumed that in the application client 1110, for example, “form1” to “form3” may be selected as qualities of video data downloaded from a server. The application client 1110 notifies the requested downlink throughput setting unit 1130 of the form that has been selected (selected form).

The storage unit 1120 stores a table 1.121. In the table 1121, the selected form in the application client 1110 is correlated with the requested downlink throughput. In an example depicted in FIG. 11, “form1” to “form3” are correlated with 5 [MBPS], 10 [MBPS], and 20 [MBPS], respectively, in the table 1121.

The requested downlink throughput setting unit 1130 acquires from the table 112 stored in the storage unit 1120, the requested downlink throughput correlated with the selected form for which notification has been received from the application client 1110. The requested downlink throughput setting unit 1130 sets the acquired downlink throughput as the requested downlink throughput of the mobile terminal 110.

The requested downlink throughput detecting unit 1043 detects the requested downlink throughput of the mobile terminal 110 by acquiring the requested downlink throughput set by the requested downlink throughput setting unit 1130. For example, if “form1” is set in the application client 1110, the requested downlink throughput setting unit 1130 sets 5 [Mbps] as the requested downlink throughput.

Multiple application clients 1110 may be present and, in this case, fox each of the application clients 1110, the table 1121 is stored in the storage unit 1120. The requested downlink throughput setting unit 1130 acquires the requested downlink throughput from the table 1121 for each of the application clients 1110. The requested downlink throughput setting unit 1130 sets the sum of the acquired requested downlink throughputs as the requested downlink throughput of the mobile terminal 110.

The service of the application client 1110 is not limited to a video streaming service, and various services such as Voice over IP (VoIP), videophone, and file transfer are applicable.

As described above, the requested downlink throughput detecting unit 1043 may refer to the table 1121 (correlation information) of a state of an application executable in the mobile terminal 110 (the terminal of the requested downlink throughput detecting unit 1043) and a data amount requested by the mobile terminal 110. The requested downlink throughput detecting unit 1043 detects the data amount corresponding to the state of the application being executed by the mobile terminal 110, based on the table 1121.

As described above, according to the mobile terminal and the control method, electric power can efficiently be used.

For example, in the conventional operation of LTE-A, if a wireless environment is good, multiple secondary CCs are used without consideration of the state of the mobile terminal. Therefore, for example, a secondary cell search is always performed for multiple secondary CCs and the communication quality does not improve despite a large consumption of electric power in some cases.

In contrast, according to the mobile terminal 110, for example, during high-speed movement while the communication quality of the secondary CCs frequently drops, the switching of the secondary CCs and the secondary cell search for selecting a secondary cell can be terminated. As a result, power consumption that does not lead to improvements in the communication quality can be reduced.

An aspect of the present invention enables efficient use of electric power.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A mobile terminal comprising:
a receiving unit that is configured to enable reception of a wireless signal by concurrently using a cell of a first frequency bandwidth and a cell of a second frequency bandwidth that is different from the first frequency bandwidth, the cell of the second frequency bandwidth having a range that is smaller than the cell of the first frequency bandwidth;
a measuring unit that is configured to measure reception quality of each cell of the second frequency bandwidth;
a setting unit that is configured to set among the cells of the second frequency bandwidth and based on a result of measurement, a cell that is to be used by the receiving unit;
a detecting unit that is configured to detect a movement speed of the mobile terminal; and
a control unit that is configured to terminate the measurement when the detected movement speed exceeds a predetermined speed.

2. The mobile terminal according to claim 1, wherein
the setting unit sets a bandwidth that is to be used by the receiving unit, based on a monitoring result of an occurrence of events that includes a predetermined event that is based on a measurement result of reception quality for the cells of the second frequency bandwidth, and
the setting unit terminates monitoring of occurrence of the predetermined event when the detected movement speed exceeds a predetermined speed.

3. The mobile terminal according to claim 1, wherein
the setting unit sends to a base station, information that includes a result of the measurement and consequently receives from the base station, information that indicates the cell that is to be used by the receiving unit among the cells of the second frequency bandwidth, the setting unit setting according to the received information, the cell that is to be used by the receiving unit.

4. The mobile terminal according to claim 1, wherein
the control unit, after terminating the measurement, resumes the measurement when the detected movement speed becomes at most the predetermined speed.

5. The mobile terminal according to claim 1, wherein
the detecting unit detects a remaining battery amount of the mobile terminal, and
the control unit terminates the measurement when the detected remaining battery amount falls below a predetermined remaining amount.

6. The mobile terminal according to claim 5, wherein
the control unit, after terminating the measurement, resumes the measurement when the detected remaining battery amount becomes at least the predetermined remaining amount and the detected movement speed is at most the predetermined speed.

7. The mobile terminal according to claim 1, wherein
the detecting unit detects a data amount requested for transmission to the mobile terminal, and
the control unit terminates the measurement when the detected data amount falls below a predetermined data amount.

8. The mobile terminal according to claim 7, wherein
the control unit, after terminating the measurement, resumes the measurement when the detected data amount becomes at least the predetermined data amount and the detected movement speed at most the predetermined speed.

9. The mobile terminal according to claim 7, wherein
the detecting unit detects based on correlation information of states of applications executable by the mobile terminal and data amounts requested for transmission to the mobile terminal, a data amount that corresponds to the state of an application under execution by the mobile terminal.

10. A control method of a mobile terminal that is configured to enable reception of a wireless signal by concurrently using a cell of a first frequency bandwidth and a cell of a second frequency bandwidth that is different from the first frequency bandwidth, the cell of the second frequency bandwidth having a range that is smaller than the cell of the first frequency bandwidth, the control method comprising;
measuring reception quality of each cell of the second frequency bandwidth;
setting among the cells of the second frequency bandwidth and based on a result of measurement, a cell that is to be used for receiving a wireless signal;
detecting a movement speed of the mobile terminal; and
terminating the measurement when the detected movement speed exceeds a predetermined speed.
